(19) United States
(12) Patent Application Publication
(10) Pub. No.: US 2002/0184634 A1
(43) Pub. Date: Dec. 5, 2002

(54) Television rides

(76) Inventor: Robert M. Cooper, Arlington, VA (US)

Correspondence Address: JOHN F. HAYDEN, Fish & Richardson P.C., 601 Thirteenth Street, NW, Washington, DC, 20005, US

(21) Appl. No.: 09/867,692

(22) Filed: May 31, 2001

(51) Int. Cl. H04N 7/025; H04N 7/10; G06F 3/00; H04N 5/445; G06F 13/00

(52) U.S. Cl. 725/51; 725/32; 725/37; 725/36; 725/43

(57) ABSTRACT

A TV ride includes an automated sequence of TV and/or web content that is presented to a viewer using a display device and a set top box. TV rides provide a viewer with a number of predetermined TV programming lineups that may be presented by automatically tuning the viewer's set top box to the channels corresponding to the TV programming lineup associated with the TV ride. During the TV ride, the viewer may be presented with a number of interactive events or opportunities. For example, the TV ride may display an interactive viewer poll. In addition, chat rooms may be created for online discussions about the TV ride and its related topics. If enough interest is generated in a TV ride, a community corresponding to the TV ride may be generated. The TV community may include information on upcoming lineups, chat rooms, community e-mail, community shopping, and other community-oriented aspects.

This application claims priority from U.S. application Ser. No. 09/584,348, filed Jun. 1, 2000, and titled “Managing Electronic Content from Different Sources,” and U.S. application Ser. No. 09/828,469, filed, Apr. 9, 2001, and titled “Contextual Programming,” both of which are incorporated by reference.

### TECHNICAL FIELD

This invention relates generally to interactive television programming and in particular to an automated sequence of television content.

### BACKGROUND

With the proliferation of cable and satellite television (TV), the number of channels available to a TV viewer has dramatically increased. As a result, a viewer now has access to an unprecedented variety of TV content. However, the vast number of channels has made the selection of TV content more difficult. In response, TV content providers have created electronic program guides (EPGs) to aid viewers in their selection of TV content. An EPG helps the viewer by displaying an overview of the programming available at any date and time. Using the EPG, a viewer can determine the date and time associated with particular TV content. In addition, the EPG is displayed on a viewer's TV and requires minimal instruction to use. However, even with the aid of an EPG, some viewers find it difficult to quickly and easily locate programming of potential interest.

### SUMMARY

In one general aspect, a TV ride includes an automated sequence of TV and/or web content that is presented to a viewer using a display device and a set top box. TV rides provide a viewer with a number of predetermined TV programming lineups that may be presented by automatically tuning the viewer's set top box to the channels corresponding to the TV programming lineup associated with the TV ride. During the TV ride, the viewer may be presented with a number of interactive events or opportunities. For example, the TV ride may display an interactive viewer poll. In addition, chat rooms may be created for online discussions about the TV ride and its related topics. If enough interest is generated in a TV ride, a community corresponding to the TV ride may be generated. The TV community may include information on upcoming lineups, chat rooms, community e-mail, community shopping, competitive events between ride participants, and other community-oriented aspects.

Implementations may include one or more of the following features, for example a TV ride includes receiving a TV ride selection, accessing a TV ride lineup associated with the TV ride selection, and automatically tuning to a channel providing TV programming. The received TV ride lineup may be transmitted from a host.

The TV ride lineup may be stored and accessed at the set top box. Accessing the TV ride lineup may include accessing data identifying a desired TV programming included in the TV lineup. The identifying data may be processed to determine the channel and a time associated with the desired TV programming.

A display screen for presenting the TV programming may be divided into a number of windows. The windows may display interactive opportunities. The interactive opportunities may include, for example, a viewer poll, an advertisement, a link to web content, or a chat room.

The TV ride may be a sponsored TV ride, a thematic TV ride, a spawned TV ride, or a viewer-created TV ride. The spawned TV ride may be one of a viewer-spawned TV ride or a poll-spawned TV ride. A rating of the TV programming may be received and used to generate a poll-spawned TV ride.

Parameter data indicating a selection of TV programming may be generated. The parameter data may be transmitted, and a TV ride lineup based on the generated parameter data may be received. Additional TV ride lineup data may be periodically received from a host, and the TV ride lineup may be updated based on the additional TV ride lineup data.

In another general aspect, a set top box includes an interface for receiving a TV ride selection and a processor for accessing a TV ride lineup associated with the TV ride selection. In addition, the processor may automatically tune to a channel providing TV programming based on the accessed TV ride lineup. An interface for receiving the TV ride lineup and a memory for storing the TV ride lineup also may be provided.

The processor access the TV ride lineup stored in the memory. The processor also may access data identifying the TV programming included in the TV ride lineup. A channel and a time associated with the TV programming are determined by the processor based on the data identifying the TV programming.

An interface may provide a video output. The video output may present as a display screen the TV programming to which the processor automatically tunes. Windows in the display screen may be generated by the processor. Data relating to an interactive opportunity may be received by an interface and placed in a window. In addition, the processor may generate a window in response to received interactive opportunity data. The window may be used to display an interactive viewer poll, an advertisement, a link to a web page, or a link to a chat room.

Parameter data indicating a selection of TV programming may be generated by the processor. A TV ride lineup may be received by an interface based on the generated parameter data.

In another general aspect, a TV ride may be provided by receiving a TV ride selection, determining a TV ride lineup in response to the TV ride selection, including data for automatically tuning to TV programming for more than one channel, and transmitting the TV ride lineup to a set top box. As a result, the TV ride lineup my be prerecorded in addition to live.

In yet another general aspect, a host for providing a TV ride includes an interface for receiving a TV ride selection; a processor for determining a TV ride lineup for the TV ride selection, including data for automatically tuning to TV programming for more than one channel; and an interface for transmitting the TV ride lineup to a set top box.

Other features and advantages will be apparent from the description, the drawings, and the claims.

### DESCRIPTION OF DRAWINGS

FIG. 1 is a block diagram of an exemplary set top box system.

FIG. 2 is a block diagram of an exemplary set top box of the system of FIG. 1.

FIGS. 3A and 3B are exemplary display screens associated with TV rides and generated by the set top box of FIG. 2.

FIG. 4 is a flow chart of a procedure implemented by the set top box of FIG. 2 for processing a TV ride.

FIG. 5 is an exemplary flow chart of a procedure implemented by the set top box of FIG. 2 for creating and processing a viewer-created TV ride.

Like reference symbols in the various drawings indicate like elements

### DETAILED DESCRIPTION

### System Overview

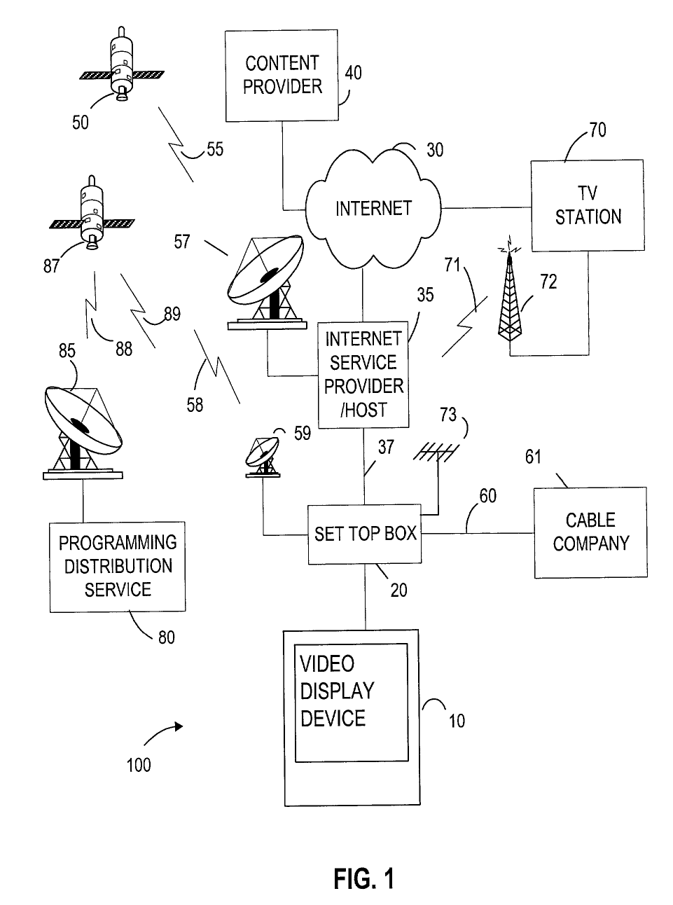

An exemplary set top box system 100 is shown in FIG. 1. The system 100 includes a video display device 10 connected to set top box 20. The video display device 10 may be implemented using, for example, an analog TV, a digital TV, a high definition TV (HDTV), a video monitor, or another device capable of displaying analog and/or digital video signals.

The set top box 20 gathers and manages content for presentation on the video display device 10. The set top box 20 generally gathers and manages two primary types of content: web content and TV content. Web content includes, for example, digital information that is typically, but not exclusively, communicated over a communications network. Examples of web content include: a web page, an image file, an audio file, a video file, a data file, a program, an e-mail, an instant message, and a chat session. TV content may include digital and analog information intended for presentation on a video display device that generally corresponds to established standards, such as, for example, European Telecommunications Standards Institute (ETSI), Digital Video Broadcasting (DVB), Advanced Television Systems Committee (ATSC), or European Cable Communications Association (ECCA). Examples of TV content include a broadcast TV program, a satellite TV program, a cable TV program, an output of a video player/recorder device, such as, for example, a videocassette recorder (VCR), a laser disc player, and a digital videodisk (DVD) player, digital video recording (DVR), or output of a video camera.

The set top box 20 may use a variety of methods to gather web and TV content. The set top box 20 can be configured to receive web content from sources, such as an ultra high frequency (UHF) or a very high frequency (VHF) transmitter, a digital transmitter, a radio frequency (RF) transmitter, a satellite transmitter, a cable TV provider, and the Internet. For example, the set top box 20 can access web content over the Internet 30 through a connection to an Internet service provider (ISP) or host 35, such as America Online (AOL™). The set top box 20 connects to the host 35 through a wired or wireless communications link 37 (e.g., a plain old telephone service (POTS), a digital subscriber line (DSL), or an integrated systems digital network (ISDN)) that typically is provided by a telecommunications company. Once connected to the host 35, the set top box 20 can gather web content from any number of content providers 40 connected to the Internet 30. Although shown as a single entity in FIG. 1, the host 35 may include one or more computers, processors, servers, and other equipment for performing various functions associated with the ISP.

The set top box 20 also can access web content from a satellite 50. The satellite 50 receives the web content from an uplink 55 provided by a transmitter 57 connected to, for example, the host 35. The web content is provided to the set top box 20 through a downlink 58 from the satellite 50 to a receiving dish 59. Similarly, the set top box 20 may receive web content through a cable communications link 60 connected to a cable company 61. Furthermore, web content may be inserted in the vertical blanking interval (VBI) of a TV signal (e.g. broadcast, cable, or satellite). Examples of using the VBI to send web content to the set top box 20 are described in U.S. application Ser. No. 09/584,347 filed Jun. 1, 2000, titled “Online/Offline Triggers,” which is incorporated by reference in its entirety.

The set top box 20 may receive TV content from a number of sources. For example, a TV station 70 may broadcast UHF and VHF TV signals 71 from a TV transmitter tower 72. An antenna 73 connected to the set top box 20 receives the TV signals 71. Likewise, a TV programming distribution service 80 (e.g., Direct TV™) can transmit TV content from a transmitter 85 to a satellite 87 for transmission to the receiving dish 59 connected to the set top box 20 using an uplink 88 and a downlink 89. TV content also may be provided directly to the set top box 20 by the cable company 61 using cable communications link 60.

### Set Top Box

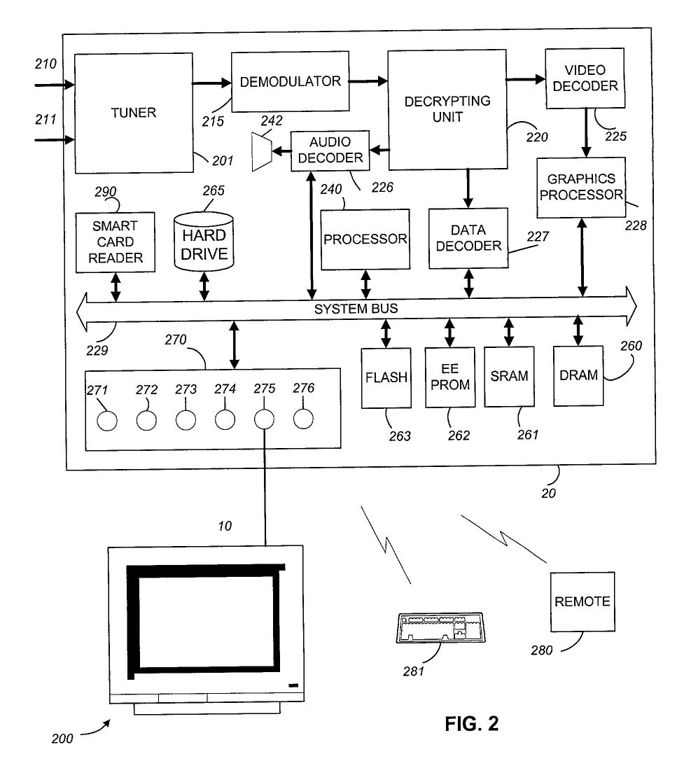

Referring to FIG. 2, an example of set top box system 20 connects to video display device 10 to form a system 200 that includes a tuner 201. The tuner 201 may receive quadrature amplitude modulation (QAM), orthogonal frequency division multiplexing (OFDM), and quadrature phase shift key (QPSK) digital TV signals 210. The digital TV signals 210 are received by the tuner 201 from various components, such as, for example, cable communications link 61 of system 100. Similarly, analog TV signals 211 are provided to the tuner 201 using various components, such as, for example, antenna 73 of system 100. The tuner 201 may be implemented using a broadcast in-band tuner, an out-of-band tuner, and a return path tuner. In addition, the TV tuner 201 may receive TV signals 210 or 211 from a video recorder/player device (e.g., a VCR, a DVD player, or a laser disc player); however, a separate interface also may be provided for receiving these signals (as described in detail below). The tuner 201 generally isolates a physical channel from the received signal 210 or 211 and converts it to a baseband signal.

The analog baseband signal output from the tuner 201 is sent to a demodulator 215. The demodulator 215 samples an analog signal and converts it to a digital bit-stream (e.g., a Moving Pictures Experts Group (MPEG)-2 bit stream). The data may be organized in discrete units, such as, for example, data packets. The bit-stream may include video, audio, and other data. The bit-stream is checked for errors and is forwarded to a unit 220 that examines the packets in the bit-stream, selects particular packets, and forwards the packets to one or more of a video decoder 225, an audio decoder 226, or a data decoder 227.

The video decoder 225 transforms video packets into a sequence of pictures which may be displayed on the display device 10. The output from the video decoder 225 may be sent to an optional graphics processor 228 for enhanced TV and web content display. If a graphics processor is not included, the output of the video decoder 225 is sent directly to the system bus 229. The system bus 229 provides a communications path between the processor 240 and the various components of the set top box 20.

The audio decoder 226 decompresses an audio bit-stream received from the unit 220, and delivers the decompressed audio bit-stream to a speaker 242 or to the system bus 229.

The data decoder 227 is connected to the system bus 229 and decodes data packets received from the unit 220 or the system bus 229. The data decoder 227 ueses the system bus 229 to deliver the decoded data packets for processing by a processor 240 or other set top box components.

The processor 240 operates according to any number of operating systems include these available from, for example, Power TV, VxWorks, pSOSystem, Microware, Microsoft, or Linux. The processor 240 provides a number of functions for the set top box 20. The processor 240 initializes the set-top box hardware, monitors and manages hardware interrupts, and fetches data and instructions from memory. The processor 240 also processes a range of web and TV content data. The processor 240 also may execute various programs and applications, such as, for example, a browser, stored in the memory or storage of the set top box 20.

The set top box 20 may include a number of memories. For example, a random access memory (RAM) can be used as a temporary storage area for data flowing between the processor 240 and set top hardware. Dynamic RAM (DRAM) 260 and static RAM (SRAM) 261 are examples of memory that may be used. The DRAM 260 typically is used for interactive applications, while the SRAM 261 generally is used to support time sensitive applications, such as MPEG processing.

Non-volatile memory, such as an electrically erasable programming read only memory (EEPROM) 262 and a flash memory 263, also may be provided. The EEPROM 262 generally is used to store control programs and boot-up information for the processor 240. The flash memory 263 may be used to store programs and customer specific information. In addition, the flash memory 263 may be used to store data downloaded from the host 35 to provide additional functionality to the set top box 20 and store temporary data that is continually updated.

The set top box 20 also may include one or more large-scale memory devices, such as a hard drive 265. The hard drive 265 may be used to store TV and web content, such as, for example, personal documents, favorite Internet sites, email, recorded TV content, data files, audio files, video files, programs, and other data.

The set top box 20 may include a number of input/output (I/O) interfaces 270 including: a modem 271, a high-speed multimedia interface 272, a serial interface 273, a common interface 274, a TV and VCR interface 275, and a wireless interface 276 to wireless devices, such as a remote control 280 and a wireless keyboard 281. The set top box also may include a smart card reader 290. The I/O interfaces provide a communications path between external devices and the system bus 229 to facilitate the exchange of data with the set top box 20. The set top box 20 may include one or more of these interfaces.

The modem 271 facilitates two-way interactivity between the set top box 20 and the host 35 or a service provider (e.g., cable company 61). Once activated, the modem 271 can send a request to a web server on the Internet 30, download a file, send an email, and facilitate a two-way interactive service, such as home shopping or video-on-demand. The high-speed multimedia interface 272 allows the set top box 20 to communicate in real time with other devices, such as a camcorder, a DVD player, a laser disk player, a CD player, and a digital camera.

The high-speed interface 272 may be implemented using various hardware devices, such as, for example, an IEEE 1284 parallel port, a universal serial bus, and a 10/100 Base-T (i.e., Ethernet) device.

The serial interface 273, for example, an RS-232 interface, provides a serial communications interface that allows the set top box 20 to exchange data with other devices, such as, for example, a printer, a computer, a personal data assistant (PDA), or an external storage device.

The common interface 274 may provide a standardized interface to connect the set top box 20 with a separate hardware module, such as a personal computer memory card international association (PCMCIA) interface.

The TV and VCR interface 275 allows the set top box 20 to communicate with the display device 10 and a video recorder/player. The wireless remote control interface 276 receives control signals from a viewer interface device, such as, for example, a remote control device 280 and a wireless keyboard device 281. The control signals are interpreted by processor 240 to activate and control functions of the set top box 20 and the display device 10. The viewer interface devices may communicate with the remote control interface 276 using RF signals, infrared signals, or otherwise.

Smart card reader 290 may read a smart card that contains, for example, identification information for authorizing access to the host 35, accessing the programming distribution service 80, or conducting an e-commerce transaction.

The set top box 20 constructs or formats a display for presentation on a screen of the display device 10. The display may be constructed from web content, TV content, or a combination of both web and TV content. A browser application (e.g., Liberate's TV navigator) being run by the set top processor 240 creates the display from outputs of the memories (e.g., 260, 261, and 262), the hard disk 265, the I/O interfaces 270, and/or the decoders (e.g., 225, 226, and 227). The browser can support a number of computing standards including, for example, hypertext markup language (HTML), JavaScript, and hypertext transfer protocol (HTTP).

The browser integrates web and TV content by processing, for example, a window tag. A window tag is an HTML-like tag (e.g., <IMG SRC=“TV” x=0y=0>) that instructs the browser to place TV content received by the set top box 20 on the screen of the display device 10 at specified coordinates. By modifying a received web page to include a window tag, the browser can display the TV content in conjunction with web content in windows for each type of content. Any number of content windows may be displayed on a screen at one time. In addition, the windows may be separate or appear to overlap each other. Web content also may be assigned HTML-like tags indicating the arrangement of the web content on the screen. The screen of the display device 10 can be modified to insert user controls, resize the TV image, and provide interactive links by altering instructions of the web content displayed by the browser.

In addition, the set top box 20 may present content that is overlaid with user interface controls or menus. The controls and menus correspond to functions (e.g., tuning channels) performed by the set top box 20. Interactive controls and display windows also may be overlaid on the TV content or web content on the screen of the display device 10. One example of the combination of interactive displays overlaying TV content is described in U.S. application Ser. No. 09/365,734 filed Aug. 3, 1999, titled “Providing Interactive Links in TV Programming,” which is incorporated by reference in its entirety.

### TV Rides

With the explosion of content available through broadcast, cable, and satellite TV, viewers are often overwhelmed by the number of choices presented when selecting TV programming. While some people enjoy the variety of content, others are paralyzed by indecision due to the unprecedented number of available selections. EPGs provide some assistance to help viewers locate programming of potential interest. However, some viewers do not want to be bothered with the additional effort required to search through lists of TV programming to find their favorite shows. Likewise, other viewers are intimidated by or do not understand how to use EPGs. Therefore, a number of viewers desire an alternative way to find TV content using minimal effort. TV rides provide such an alternative and more.

A TV ride includes an automated sequence of TV and/or web content that may be presented to a viewer using a display device 10 and a set top box 20. TV rides provide a viewer with a number of predetermined TV programming lineups that may be presented by automatically tuning the viewer's set top box 20 to the channels corresponding to the TV programming lineup associated with the TV ride. During the TV ride, the viewer may be presented with a number of interactive events or opportunities. For example, the TV ride may display an interactive viewer poll. In addition, chat rooms may be created for online discussions about the TV ride and its related topics. If enough interest is generated in a TV ride, a community corresponding to the TV ride may be generated. The TV community may include information on upcoming lineups, chat rooms, community e-mail, community shopping, and other community-oriented aspects.

A number of different types of TV rides may be provided to a viewer. For example, TV rides may include a sponsored TV ride, a thematic TV ride, a spawned TV ride, and a viewer-created TV ride. A sponsored TV ride is produced by one or more sponsors who select the TV programming lineup of the TV ride. A thematic TV ride includes TV programming associated with a particular theme. A spawned TV ride is generated based on viewer interest and/or feedback. A viewer-created TV ride includes a TV programming lineup selected by a viewer. Each of these TV rides is described in further detail below.

During the TV ride, the host 35 may provide the viewer with various interactive events, links, data, or information. The host 35 may monitor and track all viewers that are participating in a TV ride. Based on monitored viewer data, the host 35 may provide interactive events and information to the viewer including advertising that is targeted to the viewer. Interactive events and information may be determined, for example, by a sponsor or the host 35 based on viewer demographics and other information. For example, a “Teen Night” TV ride may include the TV program “Buffy the Vampire Slayer.” At the beginning of the TV program, the host 35 may send a link to a community chat session for the Teen Night TV ride and a link to the Buffy the Vampire Slayer website. The host 35 monitors the TV ride and determines when to send or update the data relating to the interactive events and information. The browser operating in the set top box processes the data for display to the viewer. In addition, interactive events and information may be stored in a memory or storage of the set top box 20. Triggers associated with the data also may be stored in a memory or storage that cause the processor 240 to display the interactive opportunities or information at appropriate times during the TV ride.

To begin a TV ride, the viewer first selects which TV ride to take. Using a viewer interface device (e.g., 280, 281) a viewer may access a menu for display on the display device 10. In response to a signal from the viewer interface device, the processor 240 displays a control menu. The control menu may include a number of features for controlling the set top box 20 and the display device 10, including a TV ride feature. In response to selection of the TV ride feature, the processor 240 sends a request to the host for a list of available TV rides. After processing the request, the host 35 returns a list of available TV rides to the processor 240 for display to the viewer. The processor 240 displays the list of available TV rides in a TV ride menu on the display device 10. In addition to displaying the available TV rides, the TV ride menu may contain information describing the TV rides or interactive links to web pages associated with the TV rides.

A TV ride file containing TV ride data may be stored in a memory or storage of the set top box 20. The TV ride file may be periodically updated with new TV ride data, such as, for example, a list of available TV rides and their lineups. As a result, a viewer using the set top box 20 may choose a TV ride even if the set top box 20 is offline or unable to access the host 35. In addition to storing the TV ride lineup, the TV ride file may store additional information for the TV ride. For example, the TV ride file can store format data used by the browser to generate the display screen. The format data can include the number, type, and placement of windows on the display screen. Likewise, the TV ride file can contain information for display in the windows including interactive links, information, and triggers.

### TV Ride Display

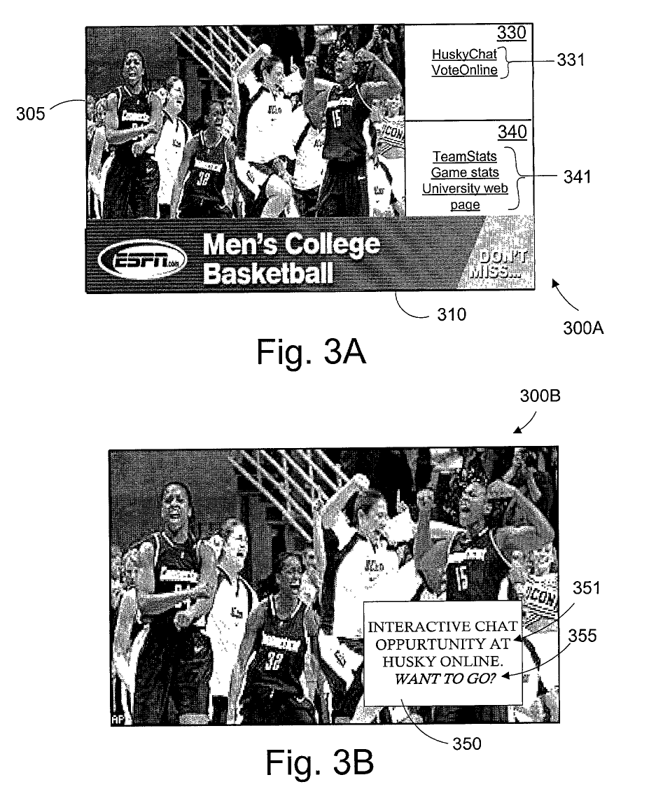

Referring to FIG. 3A, an exemplary display screen 300A for use with TV rides may be divided into a number of related or unrelated viewing windows. Window 305 may display TV programming that is associated with a selected TV ride. Window 310 may display, for example, advertisements, tickers, news, and other information of potential interest to the viewer. Windows 330 and 340 may be used to display interactive events and information to the viewer. For example, window 330 may display interactive links 331, such as, a link to a chat room or a viewer's poll. Window 340 may include a number of information links 341, such as a link to a web page. The content of each of windows 310, 330, and 340 may be related and/or determined based on the content of TV programming appearing in window 305.

The display screen 300A may be formatted for display by the processor 240. The browser, run by the processor 240, determines how the windows and their related web and TV content are presented to the viewer on screen 300A. Any number of windows may be displayed on the display screen 300A. The windows may be arranged in a format selected by the host 35 or the viewer. The format selected by the host 35 may be stored in a memory or storage of the set top box 20, for example, as a default format. When stored as a default, the processor 240 accesses the default format for display unless the viewer overrides the default selection. A viewer may choose a format for the screen, overriding the default format, by selecting a display feature from a control menu of the set top box 20. The viewer also may establish his or her own default format.

FIG. 3B shows another exemplary display screen 300B that may display TV programming. Message windows 350 may be displayed as appearing to overlay the TV content. The message window 350 may present the viewer with information and/or interactive opportunities 351. One or more interactive links 355 may be displayed in the message window 350 to connect the viewer with web content or to activate functions of the set top box 20. The message window 350 and the links 355 may be related to the content of screen 300B or the TV ride. The viewer may select or activate a function associated with the interactive link 355 using a viewer interface device. The message window 350 may appear for a predetermined period of time or until the viewer interacts with the message window 350. A description of embedding links in TV content and interactive messages can be found in the above-referenced applications titled “Providing Interactive Links in TV Programming,” and “Online/Offline Triggers.”

### Sponsored TV Rides

A sponsored TV ride is organized by one or more sponsors who determine a lineup of TV content for presentation to a viewer. For example, an automotive parts company may sponsor a racing TV ride that automatically tunes to a lineup including programs displayed on a channel showing a weekly sports talk show discussing the racing circuit, a channel showing the race of the week, and a classic sports TV channel showing previous races. In addition, the racing TV ride may include a host who introduces the TV programming, provides commentary, discusses upcoming lineups and interactive opportunities, and promotes the TV ride and/or the sponsor.

During the TV ride, the sponsor may display advertisements and commercials that promote the sponsor's and other's products and services. The advertisements may take the form of traditional commercials displayed in, for example, TV programming window 305. Advertisements also may be displayed in a number of positions, such as an advertisement window 310. Interactive events chosen by the sponsor may include chat rooms and viewer polls that may be displayed in interactive window 330 or message window 350. In addition, links to web sites of potential interest to the TV ride's viewers, for example, web sites selling the sponsor's products and services, may be displayed in information window 340 or message window 350. A community group may be organized and administered by the host 35 or the sponsor.

### Thematic TV Rides

The thematic TV ride is organized by TV programming topic. For example, a news TV ride may automatically tune to selected news programs as they occur. In this example, the set top box 20 may automatically tune to the viewer's local news channel in the early morning, a national news program, such as Good Morning America, in the late morning, and MSNBC's daily stock market report at midday. In a thematic TV ride, interactive events, information, and TV programming lineups generally are created by the host 35 based on a combination of programs from various different channels monitored by host 35. Thematic TV rides also may include a TV ride host. Community groups specific to the thematic TV ride may be automatically generated by the host 35 based on viewer participation in the TV ride.

### Spawned TV Rides

There are two types of spawned TV rides: poll-spawned rides and viewer-spawned rides. Poll-spawned TV rides are created based upon viewer polling and voting during, for example, thematic and sponsored TV rides. For example, viewers may be asked to rate individual shows according to a rating scheme (e.g., good, okay, and bad). Shows that are rated “good” over a period of time (e.g., a week, a month, or a season) may be included in a “Most Popular Shows” TV ride. The Most Popular Shows TV ride also may be categorized, for example, by interest, genre, and age, to create multiple most-popular-show rides, such as, for example, a most popular teenagers' shows TV ride. Interactive events in the poll-spawned TV ride may be determined by the host 35. The events could include, for example, links to a show's website or viewer fan site, shopping opportunities, a chat room, and other sites of potential interest to the show's viewers. Interactive polls may be presented to request information from viewers about the TV ride and other topics. For example, the host 35 may poll viewers to determine their favorite show, actor, or color. Interactive events and information may be displayed using windows 330, 340, and 350, as described above. Community groups specific to the poll-spawned TV ride also may be determined by the host 35 based on, for example, viewer interest. A TV ride show-host may be included with the poll-spawned TV rides.

Viewer-spawned TV rides are created automatically, for example, by tuning the viewer's set top box 20 to the TV program that is being watched by the most TV viewers connected to the host 35 at any given time. As viewership changes from one TV program to another, individual viewers may be invited to follow the viewer-spawned TV ride. Interactive events and information are determined by the host 35 in a viewer-spawned TV ride. Community groups specific to the viewer-spawned TV ride also are automatically determined by the host 35.

### Viewer-Created TV Rides

Another type of TV ride is the viewer-created TV ride. In a viewer-created TV ride, the viewer selects the TV programming that will be used to generate a viewer-created TV ride lineup. After creating a lineup, the viewer's set top box 20 automatically tunes to the selected TV programming. Interactive events may be incorporated, for example, where the TV program in a viewer-created TV ride intersects with the TV program featured in another TV ride. The host 35 also may associate interactive links with TV programming selected by the viewer or based on viewer demographic data or otherwise. The viewer creating the TV ride may send invitations to other viewers to join the viewer-created TV ride. Communities specific to the viewer-created TV ride may be determined by the viewers that are participating in the TV ride.

### Processing of Non-Viewer-created TV Rides

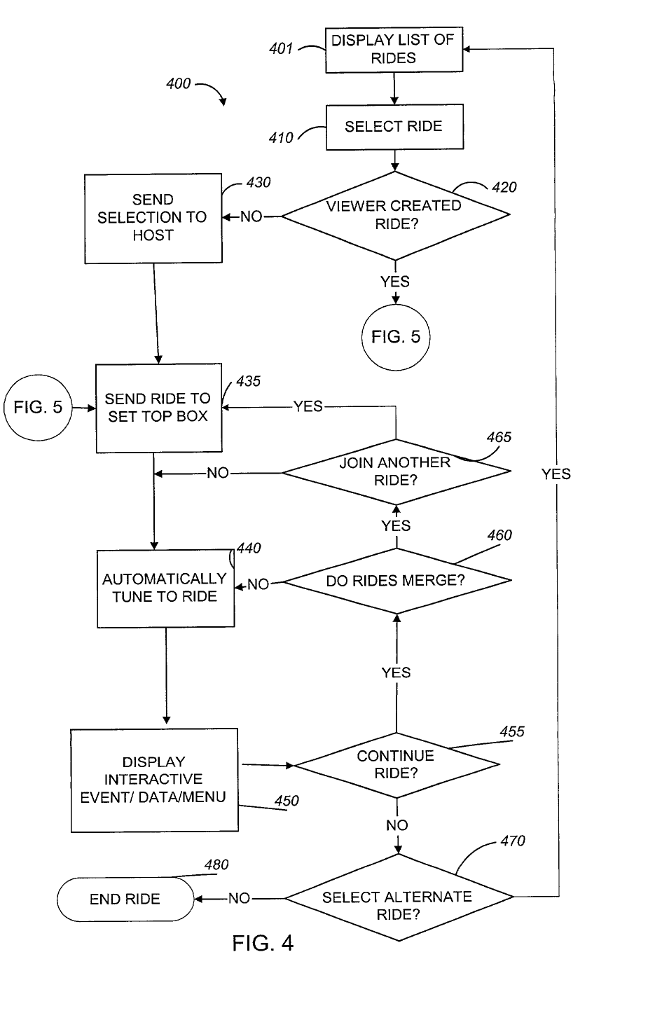

FIG. 4 shows an exemplary procesure 400 for processing a TV ride. Initially, the processor 240 accesses the TV ride file to display a list of the available TV rides (step 401). Using a viewer interface device, the viewer selects a TV ride from the list of available TV rides (step 410). The viewer's selection is received by an interface of the set top box (e.g., 276) and is interpreted (e.g., by the processor 240). The processor 240 determines if the selection is a viewer-created TV ride or non-viewer-created TV ride (e.g., a sponsored TV ride) (step 420).

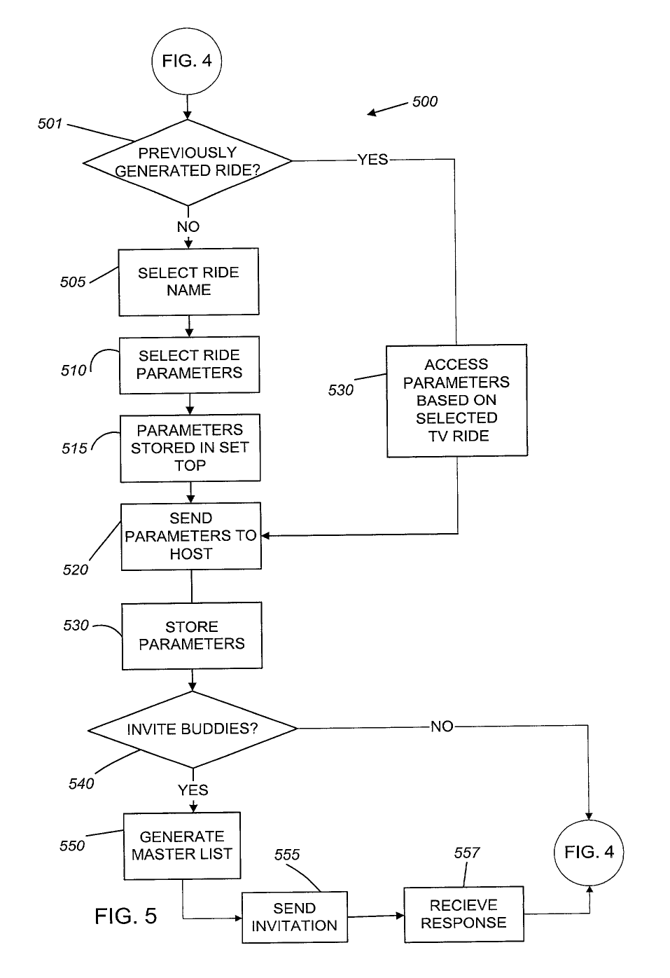

If a non-viewer-created TV ride is selected (viewer-created rides are described below with regard to FIG. 5), an indication of the selected TV ride is sent to the host 35 using an interface of the set top box 20, such as, for example, modem 271 (step 430). In response, the host 35 sends a TV ride lineup corresponding to the selected TV ride to the set top box 20 (step 435). The TV ride lineup includes data that is interpreted (e.g., by the processor 240) to provide channels and times associated with TV programming content, and may be stored in the TV ride file.

The TV ride lineup and the lineup data are processed to automatically tune to the source of TV programming indicated by the channel and time indicated by the TV ride line up (step 440). However, as described above, the TV ride lineup associated with each TV ride also may be periodically sent to and stored in a memory or storage of the set top box 20. For example, TV ride lineups may be sent to the set top box 20 the first time that a viewer selects the TV ride feature from the control menu. Thereafter, TV ride lineups may be periodically downloaded and updated with TV ride data received from the host 35 when the set top box 20 is connected to the host 35. In this case, the processor may determine if a TV ride lineup is stored in the memory or storage of the set top box 20 before contacting the host 35 for the TV ride lineup. As a result, even if the set top box 20 is offline, the viewer may select and view a TV ride. Moreover, some of the most popular TV rides may be stored and updated in the set top box 20, including TV rides in which the viewer regularly participates. If any desired TV ride information is not stored in the TV ride file, the processor 240 may contact the host 35 to receive the TV ride lineup (e.g., as described with regard to steps 430 and 435).

During the TV ride, the TV ride file may be accessed to display interactive links and information to the viewer (step 450). The interactive links and information may be sent from the host 35 before or during the TV ride. In addition, the interactive links and information may be periodically stored in a memory or storage of the set top box 20, such as, for example, in the TV ride file. The display of the links and information may be triggered or accessed during a TV ride, as described above.

At the end of each program in the TV ride, the viewer may determine whether to continue the TV ride (step 455). If the viewer wants to continue the TV ride, the set top box 20 automatically continues to tune to the selected TV ride lineup (step 440). In addition, the processor 240 or the host 35 may determine that the displayed TV programming is simultaneously showing in another ride (step 460). In other words, the viewer selected TV ride lineup may merge or intersect with another TV ride's lineup for any particular show. In this case, the viewer may be presented with the option of joining the other TV ride (step 465). If the viewer does not want to join the other ride, the set top box 20 continues to display the selected TV lineup (step 440). If the viewer decides to switch rides, the other TV ride line up is sent to the set top box 20 or accessed from the TV ride file (step 435).

If the viewer wants to end a TV ride, the viewer is provided with the option of selecting another TV ride (step 470). Using the viewer interface device, the viewer may display the TV ride menu to select from the list of available TV rides (step 401). If the viewer does not wish to continue on any TV rides, the TV ride is ended (step 480) and the viewer can tune the set top box 20 if desired.

In addition, at any time during a TV ride a viewer may leave the TV ride by displaying the TV ride menu and selecting an exit feature using, for example, a viewer input device (step not shown). In this case, the viewer also may be given the option to select another TV ride (step 470) or to end the TV ride (step 480).

### Processing of Viewer-created TV Rides

FIG. 5 shows an exemplary procedure 500 for processing a viewer-created TV ride. As described above with regard to FIG. 4, a list of available TV rides is displayed in the TV ride menu (step 401). Previously-generated viewer-created TV rides also are displayed in the TV ride menu. In addition, the TV ride menu includes an option to generate a viewer-created TV ride. When the viewer makes a selection from the TV ride menu, the processor 240 determines if the viewer has selected a viewer-created TV ride (step 410). If a viewer-created TV ride is selected, the processor 240 determines if the selected TV ride is a previously generated viewer-created TV ride (step 501).

If a viewer decides to generate a viewer-created TV ride, the viewer names the TV ride using a viewer input device (step 505). When generating a viewer-created TV ride, the viewer also selects TV ride parameters (step 510). The parameters include, for example, the TV programming that is to be provided in the TV ride. The viewer may choose TV programming to be included in the ride by selecting a series of particular channels and time slots. Likewise, the viewer may specify the name of a TV program or other identification that is automatically recognized by the host 35. An EPG may be used to facilitate the selection of TV programming for the viewer-created TV ride, where the viewer may select TV programming from the EPG using a viewer input device. The selected TV programming is tagged by the processor 240 to indicate that a particular show that has been selected. Regardless of the method of selection, the parameters indicating which TV programming has been selected are stored in a memory or storage of the set top box, such as, for example, in the TV ride file (step 515). The parameters also are sent to the host 35 (step 520).

If the viewer selects a previously generated viewer-created TV ride (step 501), the processor 240 accesses the stored parameters associated with the selected viewer-created TV ride (step 530). After accessing the stored parameters, the processor 240 sends the parameters to the host 35 (step 520).

The host 35 generates a TV ride lineup from the parameters received from the viewer's set top box 20 (step 530). After generating the TV ride lineup, the host 35 determines if the viewer would like to invite any buddies to join the ride (step 540). If the viewer wants to invite buddies, the viewer may select the buddies to join the TV ride. Contact information for the viewer's buddies may be stored in a memory or storage of the set top box 20 and accessed by the processor 240. The contact information also may be stored and downloaded from the host 35 to the set top box. In addition, as another option, the viewer may select buddies when determining the viewer-created TV ride line up. According to this option, the contact information for the buddies selected by the viewer may be gathered with the parameters in step 510. The contact information is provided to the host 35 with the TV ride parameters before or after the TV ride parameters are supplied to the host 35. A master list of all buddies invited to join the TV ride is created from the selected contact information (step 550), and the host 35 sends an invitation to all selected buddies (step 555). The invitation may be presented in, for example, a message window 350 on the screen of the display device 10. A buddy may accept, ignore, or decline the invitation to join the TV ride. If a buddy accepts the invitation, a message is generated by the processor 240 of the buddy's set top box 20 and sent to the host 35 (step 557).

The host 35 sends a TV ride lineup to the viewer and all buddies who accepted the viewer's invitation to join the ride as described in FIG. 4 (step 435). Although invitations are typically sent before or at the beginning of the TV ride, the invitations can be extended to and accepted by buddies at any time during the TV ride.

After the TV ride line up is sent, the set top boxes automatically tune to the TV ride (step 440). Thereafter, the TV ride is processed according to FIG. 4 in the manner described above.

A number of implementations have been described. Nevertheless, it will be understood that various modifications may be made. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

In the claim:

1. A method for presenting a television (TV) ride, the TV ride including an automated sequence of TV programming, comprising:
receiving a TV ride selection;
receiving, from a host, a TV ride lineup associated with the TV ride selection, the TV ride lineup specifying TV programming provided by more than one channel;
accessing the TV ride lineup; and
automatically tuning to a channel that provides the TV programming based on the accessed TV ride lineup.

2. The method of claim 1 further comprising storing the TV ride lineup, wherein accessing the TV ride lineup includes accessing the stored TV ride lineup.

3. The method of claim 1 wherein accessing the TV ride lineup includes accessing data identifying TV programs included in the TV ride lineup.

4. The method of claim 3 wherein automatically tuning to the channel includes processing the identifying data to determine the channel and a time associated with the TV programming.

5. The method of claim 1 further comprises displaying the TV programming and a window.

6. The method of claim 5 wherein displaying the window includes displaying an interactive opportunity in the window.

7. The method of claim 5 wherein displaying the window includes displaying a viewer poll in the window.

8. The method of claim 5 wherein displaying the window includes displaying an advertisement in the window.

9. The method of claim 1 comprising receiving an indication that the TV programming in the TV ride corresponds to TV programming in an alternate TV ride; receiving a selection to view the alternate TV ride; and receiving, from the host, the lineup associated with the alternate TV ride.

10. The method of claim 1 wherein the TV ride is a sponsored TV ride.

11. The method of claim 1 wherein the TV ride lineup is based on a theme.

12. The method of claim 1 wherein the TV ride is a spawned TV ride.

13. The method of claim 12 further comprising receiving an indication of a rating of the TV programming specified by the TV ride lineup.

14. The method of claim 12 further comprising receiving the TV lineup based on viewer poll data.

15. The method of claim 12 wherein the spawned TV ride is a viewer-spawned TV ride.

16. The method of claim 1 wherein the TV ride is a viewer-created TV ride.

17. The method of claim 1 further comprising generating parameter data indicating the TV ride programming associated with the received TV ride selection, transmitting the parameter data, and receiving a TV ride lineup based on the generated parameter data.

18. The method of claim 16 further comprising generating data indicating an invitation to join the viewer-created TV ride, and transmitting the invitation data to one or more buddies.

19. The method of claim 1 further comprising receiving the TV ride lineup based on the TV ride selection and storing the TV ride lineup.

20. The method of claim 19 further comprising periodically receiving additional TV ride lineup data from a host and updating the TV ride lineup based on the additional TV ride lineup data.

21. A set top box for presenting a television (TV) ride, the TV ride including an automated sequence of TV programming, comprising:
an interface for receiving a TV ride selection;
an interface for receiving, from a host, a TV ride lineup associated with the TV ride selection, the TV ride lineup specifying TV programming provided by more than one channel; and
a processor for accessing the TV ride lineup and for automatically tuning to a channel providing the TV programming based on the accessed TV ride lineup.

22. The set top box of claim 21 further comprising a memory for storing the TV ride lineup, wherein the processor accesses the memory to access the TV ride lineup.

23. The set top box of claim 21 wherein the processor accesses data identifying the TV programming included in the TV ride lineup when accessing the TV ride lineup.

24. The set top box of claim 23 wherein the processor determines a channel and a time associated with the TV programming based on the data identifying the TV programming.

25. The set top box of claim 21 further comprising an interface that provides a video output, wherein the video output includes a display for the TV programming provided on the channels specified by the accessed TV ride lineup.

26. The set top box of claim 25 wherein the processor generates a window for the display.

27. The set top box of claim 26 further comprising an interface for receiving data related to an interactive opportunity, wherein the processor generates the window and displays content within the window based on received interactive opportunity data.

28. The set top box of claim 26 wherein the window displays an interactive viewer poll.

29. The set top box of claim 26 wherein the window displays an advertisement.

30. The method of claim 21 further comprising an interface for receiving an indication that the TV programming in the TV ride corresponds to TV programming in an alternate TV ride; an interface for receiving a selection to view the alternate TV ride; and an interface for receiving, from the host, the lineup associated with the alternate TV ride.

31. The set top box of claim 21 wherein the TV ride is a sponsored TV ride.

32. The set top box of claim 21 wherein the TV ride is a thematic TV ride

33. The set top box of claim 21 wherein the TV ride is a spawned TV ride.

34. The set top box of claim 33 wherein the spawned TV ride is a viewer-spawned TV ride.

35. The set top box of claim 32 wherein the spawned TV ride is a poll-spawned TV ride.

36. The set top box of claim 21 wherein the TV ride is a viewer-created TV ride.

37. The set top box of claim 22 wherein the processor generates parameter data associated with the TV ride selection and the TV ride lineup receiving interface receives a TV ride lineup based on the generated parameter data.

38. The set top box of claim 36 wherein the processor generates data indicating an invitation to join the viewer-created TV ride and transmits the invitation data to one or more buddies.

39. The set top box of claim 21 further comprising an interface for receiving the TV ride lineup based on the TV ride selection and a memory for storing the TV ride lineup.

40. The set top box of claim 21 further comprising an interface for periodically receiving TV ride lineup data, wherein the processor updates the TV ride lineup based on the TV ride lineup data.

41. A method for providing a television (TV) ride, the TV ride including an automated sequence of TV programming,, the method comprising:
receiving a TV ride selection;
determining a TV ride lineup in response to the TV ride selection, the TV ride lineup including data for automatically tuning to the TV programming for more than one channel; and
transmitting the TV ride lineup to a set top box.

42. The method of claim 41 further comprising determining an interactive opportunity and transmitting data based on the interactive opportunity to the set top box.

43. The method of claim 42 wherein the data transmitted based on the interactive opportunity include a link to web content.

44. The method of claim 42 wherein the data transmitted based on the interactive opportunity include an interactive viewer poll.

45. The method of claim 42 wherein the data transmitted based on the interactive opportunity include in advertisement.

46. The method of claim 2 wherein the data transmitted based on the interactive opportunity include a link to a chat room.

47. The method of claim 41 further comprising determining the TV ride lineup based on TV programming selected by a sponsor.

48. The method of claim 41 further comprising determining the TV ride lineup based on TV programming selected according to a theme.

49. The method of claim 41 further comprising determining the TV ride lineup based on TV viewer feedback.

50. The method of claim 42 further comprising receiving an indication of a rating of TV programming.

51. The method of claim 50 further comprising generating a TV lineup based on the rating.

52. The method of claim 41 further comprising determining the TV programming to which a set top box is tuned at any time.

53. The method of claim 52 further comprising generating the TV ride lineup based on the determined TV programming.

54. The method of claim 41 further comprising receiving parameter data indicating a selection of TV programming and determining a viewer-created TV ride lineup based on the received parameter data.

55. The method of claim 54 further comprising generating invitations to join the viewer-created TV ride lineup and transmitting the invitations to one or more buddies.

56. The method of claim 41 further comprising periodically transmitting TV ride lineup update data for storage in the set top box.

57. The method of claim 52 further comprising determining that the determined TV programming corresponds to TV programming in an alternate TV ride; transmitting data indicating that the determined TV programming corresponds to the alternative TV ride.

58. The method of claim 57 further comprising receiving a selection to join the alternate TV ride and transmitting a TV ride lineup corresponding alternate TV ride.

59. A host for providing a television (TV) ride, the TV ride including an automated sequence of TV programming, comprising:
an interface for receiving a TV ride selection;
a processor for determining a TV ride lineup in response to the TV ride selection, the TV ride lineup including data for automatically tuning to the TV programming for more than one channel; and
an interface for transmitting the TV ride lineup to a set top box.

60. The host of claim 59 further comprising a processor for determining an interactive opportunity and transmitting data based on the interactive opportunity to the set top box.

61. The host of claim 60 wherein the data transmitted based on the interactive opportunity include a link to web content.

62. The host of claim 60 wherein the data transmitted based on the interactive opportunity include an interactive viewer poll.

63. The host of claim 60 wherein the data transmitted based on the interactive opportunity include an advertisement.

64. The host of claim 60 wherein the data transmitted based on the interactive opportunity include a link to a chat room.

65. The host of claim 60 further comprising a processor for determining the TV ride lineup based on TV programming selected by a sponsor.

66. The host of claim 59 further comprising a processor determining the TV ride lineup based on TV programming selected according to a theme.

67. The host of claim 59 further comprising a processor for determining the TV ride lineup based on TV viewer feedback.

68. The host of claim 59 further comprising an interface for receiving an indication of a rating of the TV programming.

69. The host of claim 68 further comprising a processor for determining TV lineup based on the rating.

70. The host of claim 59 further comprising a processor for determining what TV programming a set top box is tuned to.

71. The host of claim 70 further comprising a processor for generating the TV ride lineup based on the determined TV programming.

72. The host of claim 59 further comprising an interface for receiving parameter data indicating a selection of TV programming and a processor for determining a viewer-created TV ride lineup based on the received parameter data.

73. The host of claim 59 further comprising a processor for generating data indicating an invitation to view the viewer-created TV ride lineup and transmitting the invitations to one or more buddies.

74. The host of claim 59 further comprising a processor for periodically determining TV ride lineup update data for transmission to the set top box.

75. The host of claim 70 further comprising a processor for determining that the determined TV programming corresponds to TV programming in an alternate TV ride and for transmitting data indicating that the determined TV programming corresponds to the alternative TV ride.

76. The host of claim 76 further comprising an interface for receiving a selection to join the alternate TV ride and a processor for transmitting a TV ride lineup corresponding alternate TV ride.
